(19) United States
(12) Patent Application Publication
(10) Pub. No.: US 2007/0282923 A1
(43) Pub. Date: Dec. 6, 2007

(54) Method and apparatus for the manipulation, customization, coordination and decomposition of active data models

(76) Inventors: Christopher Ward, Glen Ridge, NJ (US); Kenneth D. Christiance, Apex, NC (US); Michael J. Spisak, East Northport, NY (US); Hui Su, Beijing (CN)

Correspondence Address: GEORGE A. WILLINGHAN, III;AUGUST LAW GROUP, LLC, P.O. BOX 19080, BALTIMORE, MD, 21284-9080, US

(21) Appl. No.: 11/445,477

(22) Filed: Jun. 1, 2006

(51) Int. Cl. G06F 17/30

(52) U.S. Cl. 707/203

(57) ABSTRACT

Methods and systems are provided for the synchronization of data elements between structured documents that utilize these data elements in the management of information technology systems and data repositories from which the data elements can be obtained. Synchronization is facilitated by the use of an active data model containing model elements associated with the data elements and containing sufficient information for the synchronization. These active data models can be created specifically for a given structured document, created by modifying a generic active data model or created as a composite of existing active data models. Synchronization updates are obtained from a central trusted data source or, using a coordination adaptor, from alternative data sources having the desired level of trust. The active data models can be decomposed into adaptive business objects that are used in the management of the information technology system.

### FIELD OF THE INVENTION

The present invention relates to the field of management and administration of information technology systems.

### BACKGROUND OF THE INVENTION

Currently, management and administration of systems, for example information technology (IT) or enterprise IT systems, requires coordination among various components in the system including, resources, data, personnel and business related materials. Management and administration of the system are accomplished by an administrator, and the administrator utilizes a significant amount of information from a variety of sources to perform its work function. This information, i.e. the business related materials and data, varies in terms of the degree of trust associated with the information, the degree of trust associated with the source of the information and the level of knowledge of the system environment required to generate the information. In addition, the type of administrator can vary in terms of the level of trust, the level of automation and the level of knowledge of the environment. Typical human administrators have a high level of knowledge of the system environment and can handle information from sources associated with a relatively low level of trust; however, administration is handled manually, which is costly in terms of time and system resources. Conversely, automated systems minimize or eliminate the need for manual management, saving time and resources; however, these systems possess no knowledge of the broad system environment, requiring task specific information from trusted and reliable sources to prevent errors or corruption in system management.

In general, IT systems are best managed in accordance with the Information Technology Infrastructure Library (ITIL), which is a framework of best practices to be used in managing the IT system. ITIL can be customized to fit a particular IT system application. One aspect of ITIL is the management of the configuration of the various components of an IT system. ITIL utilizes a configuration management database (CMDB) to facilitate its configuration management functionality. A CMDB is a repository of information about all of the components in a system and is useful in understanding the relationships among the various components in the system. The CMDB is one source of information available to a system administrator and is a managed source of information, which makes the CMDB a trusted source of information. However, the CMDB is specific to a given IT system, and a system administrator cannot customize or amend the CMDB for the administration of a particular IT system.

System administrators utilize other sources of information, referred to as scattered sources of information, in the management of IT systems. These scattered sources of information include spreadsheet documents, written documents and system nodes. The level of trust and degree of formalism vary from scattered source to scattered source. System administrators combine both the managed data extracted from the deployed environment and the scattered data to manage the IT system.

One type of scattered data document used by system administrators is a structured document that contains details about the IT system environment including resources and changes to resources that are of interest to a system administrator. Typically, these structured documents are in the form of a spreadsheet. One of the most popular of these spreadsheet documents used in service delivery management is called the Build Sheet. The Build Sheet is an example of a reasonably structured scattered data source and is used to provide resource details, e.g. about server configuration information, network configuration and the relationships between details.

Using structured documents such as Build sheets in the management and administration of IT systems facilitates the use of commercially available spreadsheets and are viewed as the authoritative source for management of the IT system. The structured document is assembled by the system administrator, and there is no other accessible data object that represents the information provided in the structured document. The structured document is used extensively in system management as approximately 75% of services provided require data that are sourced from the structured document. Examples of these provided services include, but are not limited to, monitoring data, storage information, security parameters, user ID administration, problem and change management and physical and logical server build data. However, theses structured documents lack an appropriate request/response service mechanism for sourcing data and are generally employ paper intensive request mechanisms. Also, re-keying data over and over for various requests for service is an error prone process. Moreover, there is no standardization among the various types of structured documents being used, and even though synchronization can be established initially between the CMDB and a given structured document, there is not mechanism to maintain this synchronization over time.

### SUMMARY OF THE INVENTION

The present invention is directed to methods and systems that provide for the manipulation of service management data in service delivery environments. At least a portion of the data within a structured or semi-structured document, e.g. build sheets, that is used in the management of an information technology (IT) system is also represented by one or more active data models. These active data models contain active representations of data elements that are embedded in other data repositories, Therefore, the active data models can interact with the structured document and with other data repositories within the IT system. Therefore, an active data model serves the function of an intermediary between a structured document and a data repository for obtaining updated or current values of data points from the repositories and saving those updated values in the structured document. Thus, the active data models are used to coordinate data within the structured document with a centralized data repository, for example a configuration management database (CMDB). Therefore, data is synchronized between the structured document and the centralized database.

In addition to providing active data models that are specific to a given structured document to be used in the management of a given IT system, generic active data models or composed active data models are provided. A generic data model can be customized or specialized in accordance with the demands of a particular system. Since at any given time, multiple active data models can be accessing data from a single centralized repository, systems and methods in accordance with exemplary embodiments of the present invention, the need for each active data model to accessed the centralized repository directly is minimized. In one embodiment, a coordination adaptor is provided to manage the modification of the internal behavior of an active data model based on model or user registration to coordination adaptor. In addition, active data models are decomposed in accordance with non-overlapping adaptive business objects based on analysis of lifecycle states and data attributes. One or more active business objects result from the decomposition of data in a system into business objects that have a set of states. A business object transitions through these states, and the data available is a reflection of the current state.

In one exemplary embodiment of a method for managing information technology systems in accordance with the present invention, representations of data elements contained in a structured document are synchronized with representations of the data elements contained in data sources for the data elements by using an active data model in communication with both the structured document and the data sources. The active data model contains one or more model elements, and each model element is associated with one of the data elements and contains information sufficient to facilitate communication of data element representations between the structured document and the data sources. This information includes a location reference, synchronization rules, state rules, entitlement rules, change management rules, composition rules, inter-element rules and combinations thereof. In general, the data elements in the structured document contain parameters used to manage an information technology system.

In one embodiment, the structured document containing the data elements is created, for example by the system administrator, and one or more of the data elements in the structured document are identified for synchronization. The structured document can be created in the form of a spreadsheet. In creating the active data model, a model element for each one of the identified data elements is created. The number of model elements in the active data model can vary up to a number equal to the number of representations of data elements within the structured document that are subject to synchronizing.

The active data models can be formulated from generic active data models or as composite active data models. In one embodiment, creation of the active data model includes modifying a generic active data model in accordance with the data elements and data sources associated with management of the information technology system. In another embodiment, the active data model is a composite active data model and is created by identifying two or more existing active data models, where each existing active data model includes at least one model element associated with one of the data elements contained in the structured document, and creating the composite active data model using model elements from the identified existing active data models. The composite active data model includes one or more composite elements and one or more connection elements. Each connection element contains information regarding relationships between the various existing model elements in the composite model elements. In addition to the composite elements, new model elements can also be included in the active data model. Therefore, creation of the composite active data model can also include creating new model elements in accordance with the requirements of the information technology system for which the structured document is arranged to manage.

In one embodiment, synchronization includes obtaining updated representations of the data elements from the data sources and replacing existing representations of the data elements in the structured document with the updated representations of the data elements. The flow of information can be a one-way flow or a two-way flow. In one embodiment, synchronizing the data elements includes establishing a two-way exchange of the representations of the data elements between the structured document and the data sources. These data sources can be managed data sources, scattered data sources and combinations thereof.

In one embodiment, synchronization involves creating a register containing each one of the model elements of the active data model. A trusted data source for each one of the data elements associated with the registered model elements is identified, and a trusted data source is associated with each one of the data elements associated with the registered model elements. Associating the trusted data source includes binding routing relationships between the data elements associated with each one of the registered model elements and the associated trusted data source. These associated trusted data sources include a centralized data source, a data element from a structured document, a model element from an active data model and combinations thereof. In one embodiment whne binding routing relationships, a plurality of relationship elements are defined such that each relationship element includes an identification of a data element from a structured document, an identification of a trust data source, a relationship reference index and a relationship model.

In one embodiment, the active data model is decomposed into a plurality of non-overlapping adaptive business objects. These adaptive business objects are utilized in the management of the information technology system. Utilization can be facilitated by modifying the contents of each model element to include an adaptive business object reference.

### BRIEF DESCRIPTION OF THE DRAWINGS

FIG. 1 is a schematic representation of an embodiment of a system utilizing active data models in accordance with the present invention;

FIG. 2 is an illustration of an embodiment of a model element for use in the active data model;

FIG. 3 is schematic representation of an embodiment of a composite active data in accordance with the present invention;

FIG. 4 is a schematic representation of an embodiment of a system utilizing a coordination adaptor in accordance with the present invention;

FIG. 5 is an illustration of an embodiment of a relationship element utilized by the coordination adaptor; and

FIG. 6 is an illustration of an embodiment of an active data model element referencing adaptive business objects.

### DETAILED DESCRIPTION

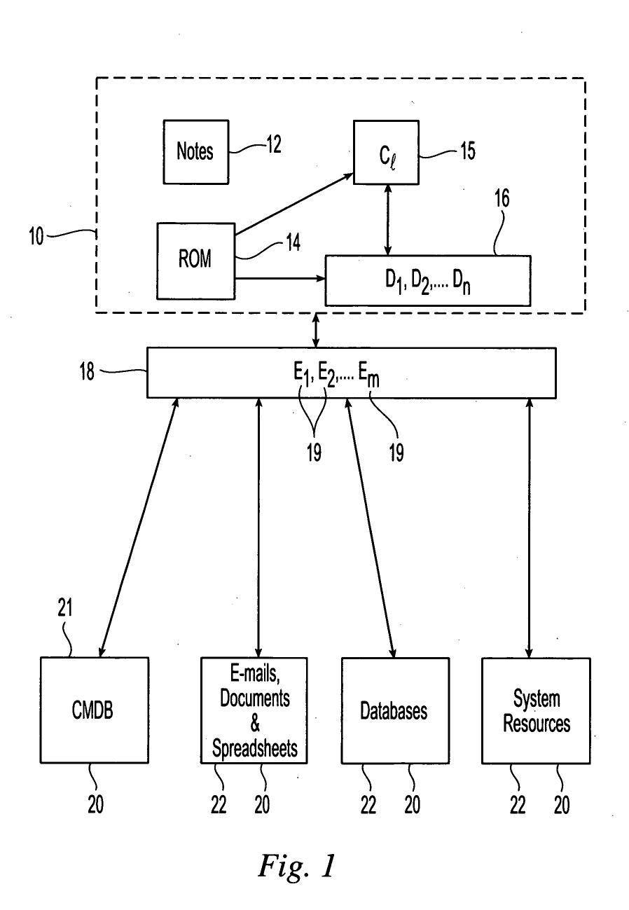

Referring initially to FIG. 1, in the management or administration of systems, for example information technology (IT) systems, in accordance with exemplary embodiments of the present invention, administrators utilize one or more structured or semi-structured documents 10. The structure document is a user-modifiable, user-readable and user-exposable document that is used to store and manipulate the data or information required by the administrator to manage the configuration of the system. One preferred type of structured document is the build sheet. A build sheet is defined as a structured document providing a representation of the configuration of a managed system. Suitable formats for the structured document include, but are not limited to, spreadsheets and word processing documents. The data stored within the structured document includes, but is not limited to, read only memory data 14, notes 12 created by the administrator regarding the operation of the system, data values 16 that can are in the form of random access memory in that the administrator can read from or write to these data points as necessary and calculated data values 15 that are values calculated internally to the structured document using other data in the structured document.

The data 16 in the structured document are obtained from a variety of sources 20 that can be internal or external to the system that is being managed. Suitable methods for obtaining and writing data to the structured document are known and available in the art and include manual and automatic methods. These sources 20 include managed data sources 21, for example databases of configuration information for example a configuration management database (CMDB), and scattered data sources 22 such as E-mails, documents, spreadsheets, other databases, and system resources such as nodes. In addition, data can be obtained from a variety of other sources that very in trust level and the degree of formalism. Communication with the various sources of data is facilitated through either a direct communication link or across one or more networks. Suitable networks include, but are not limited to, local area networks such as Ethernet networks, wide area networks such as the Internet, secure local and wide area networks, secure wireless networks, enterprise-wide networks, storage area networks, virtual private networks, secure virtual private networks, internet area networks, internet secure networks, personal area networks and combinations thereof.

At least one active data model 18 is provided in communication with the structured document 10 and the sources of data 20. An active data model is defined as a user exposable object that interacts with one or more data repositories, including centralized data repositories, to provide the dynamic materialization to the user or system administrator of the data required for system administration as expressed in the structured document. That is, the active data model makes data within the structured document or management data sources “active” and updated as opposed to stagnate and outdated. The data are provided to the user in a manner constrained by the active data model's defined behavior. In one embodiment, the active data model places constraints on the manner in which data is accessed and updated. For example, certain data elements are linked directly to corresponding configuration items and their attributes so that updates to the attribute result in a change to the underlying CMDB data element and vice-versa. Suitable formats for the active data model include, but are not limited to word processing documents and spreadsheets, such as the types of spreadsheets utilized for the structured document, and build sheets. Preferably, the active data model is provided as a spreadsheet with additional functionality to define the desired behavior of the active data model as described below.

In one embodiment, the active data model is in communication with one or more of the accessible data 16 within the structured document 10. Therefore, the active data model can write updates to the accessible data. As illustrated, the active data model is a separate element independent of either the structured document 10 or the various sources of data 20. Alternatively, the active data model can be incorporated into either the structured document or one or more of the source of data. For example, the accessible data 16 in the structured document 10 can be modified or constructed so as to be active elements. In addition, data from one or more of the data sources 20 can be modified so as to be active data points. Communication between the active data model and the structured document or the active data model and the various sources of data is preferably a two-way communication in that data or information can be passed in either direction among the various elements. Therefore the active data model is used to update both the structured document and the data sources, in particular the managed data sources 21 such as the CMDB.

The active data model includes at least one and preferably a plurality of active data model elements 19. The number of active data model elements contained in a given active data model is sufficient to facilitate the number of data points within the structured document that are to be updated on an ongoing basis. Therefore, the number of model elements 19 ranges from one up to the number of data points 16 within the structured document.

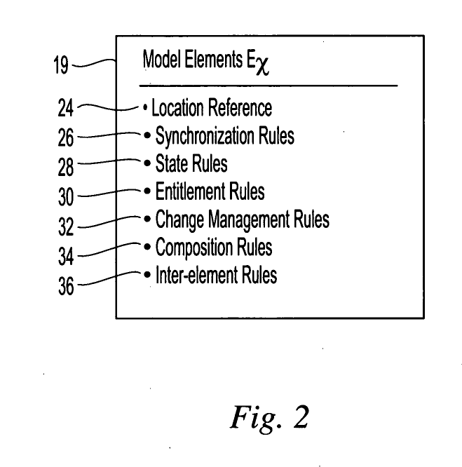

As shown in FIG. 2 a given model element 19 includes various components to facilitate the association of that model element with a given data point within the structured document and with data sources to facilitate obtaining the necessary information for the associated data point. In general, a given active data model is associated with a particular structured document that is being utilized by the administrator to manage a given system. Alternatively, a given active data model can be associated with more than one structured document, or a given structured document can have a plurality of associated active data models. In one embodiment, the active data model is associated with a build sheet, is an active object that is embedded within a spreadsheet and is responsible for coordinating and maintaining the information associated with the entire build sheet.

As shown in FIG. 2, each active data models element 19 is a component of the active data model that is associated with an individual element or data point within the structured document that is reflective of elementary data. For example, the individual element in a build sheet is a single spread sheet cell. Each active data model element contains a plurality of components that including, but are not limited to, the location reference 24, the synchronization rules 26, the state rules 28, the entitlement rules 30, the change management rules 32, the composition rules 34 and the inter-element rules 36. These components relate a given elementary data item in the structured document to the underlying data from which that data element is obtained. The active data model element provides details about the data element such as whether the element is protected or read only.

The location reference component provides details on the location of the data source, for example the reference to and location within a trusted or structured data source such as the CMDB, from which the data element is obtained. In addition to address or routing information, these details include other information such as access details including authorization and authentication data for the access to the trusted or structured data source. The synchronization rule component provides the synchronization semantics for this active data model element. Examples of the synchronization semantics include, but are not limited to, whether the synchronization is unidirectional or bidirectional, whether the synchronization will occur while the system is online or offline, the synchronization schedule, whether updates are allowed, whether there are other models or model elements that need to be synchronized and combinations thereof. The state rules component provides lifecycle state information for the active data model element. The lifecycle state of the element can be the same as or different from the lifecycle state of the active data model. The lifecycle state provides data about interaction with workflow if any is involved in this data element. The life cycle state may be used to restrict the access of the data element, for example, so that it may be modified only in particular states or used by certain administrative roles only in particular states. The entitlement rules component provides access, authentication, and entitlement information for the active data model element. The change management rules component provides details of the change management requirement for this active data model element. For example, this component provides details about whether or not the data element is under change control. Alternatively, this component provides pointers to source of this information. The composition rules component provides composition capabilities if this active data model element is derived from other active data model elements. For example, the composition rules component provides the necessary data model element references to one or more underlying elements from which this data element is derived. In addition, information about any operations among the underlying elements is also provided. The inter-element rules component 36 provides details on how this data element interacts with other active data model elements. For example, the inter-element rules may indicate preconditions for a particular active data model element based on other active data model elements.

Since the active data model provides for a two-way flow of data or information between the structured document and a data source, the active data model is used to update the data sources. In the case of trusted data sources, for example the CMDB, a level of authorization or authentication is required before the CMDB is updated. The desired level of authorization can be provided through mechanisms such as formalized request for change (RFC) mechanisms. Other levels of security or protection are provided by making certain data elements non-modifiable or read-only or by limiting change access to only certain administrators. In one embodiment, certain data elements have associated with them limited interpretation of process state. That is, there are constraints on the way that the data can be modified based on the current lifecycle. This workflow is not represented directly in the structured document; however, allowable field modifications are limited based upon a given administrator's role. In one embodiment, certain data elements have change history management or versioning requirements.

In general, the active data model itself is considered a controllable configuration item. That is, the document representing the active data model can be represented as a configuration item in a central data repository such as the CMDB. The expression of active data models within the CMBD implies that there is an awareness of these objects with respect to their use in the service delivery management (SDM).

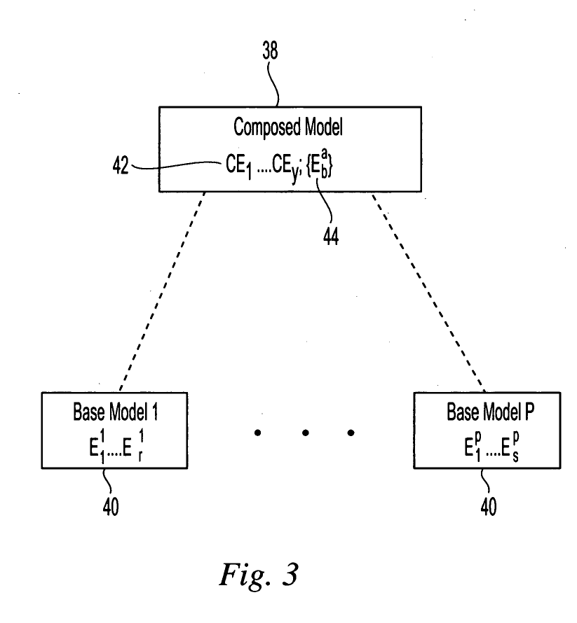

Active data models can be either specifically created for a given structured document, that is developed by the administrator for a structured document that the administrator is currently using to manage a system, or can be developed or created from one or more existing or underlying active data models. Active data models that have been created from base models can be viewed as composed active data models or generic active data models. To illustrate, again using build sheets as the structured documents, two managed systems have resource data in their respective build sheets that overlap and resource data that are specific to one of the build sheets. For example, the first system build sheet contains server and network connectivity resource information, and the second system build sheet contains network connectivity and application security information. A composite build sheet can be constructed for the second system that leverages the structure of the first system build sheet. Referring to FIG. 3, a composed active data model 38 is illustrated. The composed active data model is derived from one or more of a plurality of base active data models 40. Each base active data model contains a plurality of model elements. The model elements in the base models may overlap. For example, a given model element in one base model may be found in one or more of the other base models. In addition, certain model elements may be found in only one of the base active data models. The composed active data model utilizes these existing model elements from one or more of the base models or all of the base models in order to construct its own set of model elements 44. In addition the composed model accounts for relationships or inner connectivity between the various base model elements through one or more connection elements 42. Therefore the composed model is a composite of model elements of one or more underlying base models, eliminating the need to construct a new active data model for a given structured document. These generic or composite active data models can be further specialized in accordance with the administrative demands of a particular system.

By way of visualization, a spreadsheet provides for pages of mathematically interconnected cells. That is information from one cell references information from one or more other cells within the spreadsheet. Similarly, an active data model that is composed using one or more basic active data models can reference one or more model elements from the basic active data models in order to construct the new, composite active data model. Therefore, unlike an active data model that is not a composite and is created specifically for a given structured document, a composed active data model contains model elements from other models along with connection elements. Connection elements are similar in structure to model elements; however, connection elements provide a bridge between model elements that are contained in different basic models. A connection element provides referential information to the particular models that are used in the composed active data model. In particular, the connection element provides details of which model elements will be used from a particular model for the composition. The connection element also provides mapping details on how the identified model elements will be used in the composed model, e.g. to provide sub-elements similar to those of a model element. In general, composed models are preferable when the composed model is a composition of base models, and the model elements are largely independent and disjoint with few connections. For composed models where there is a deep nesting of relationships, management of the interconnections is more complex, and construction of a new active date model is preferred.

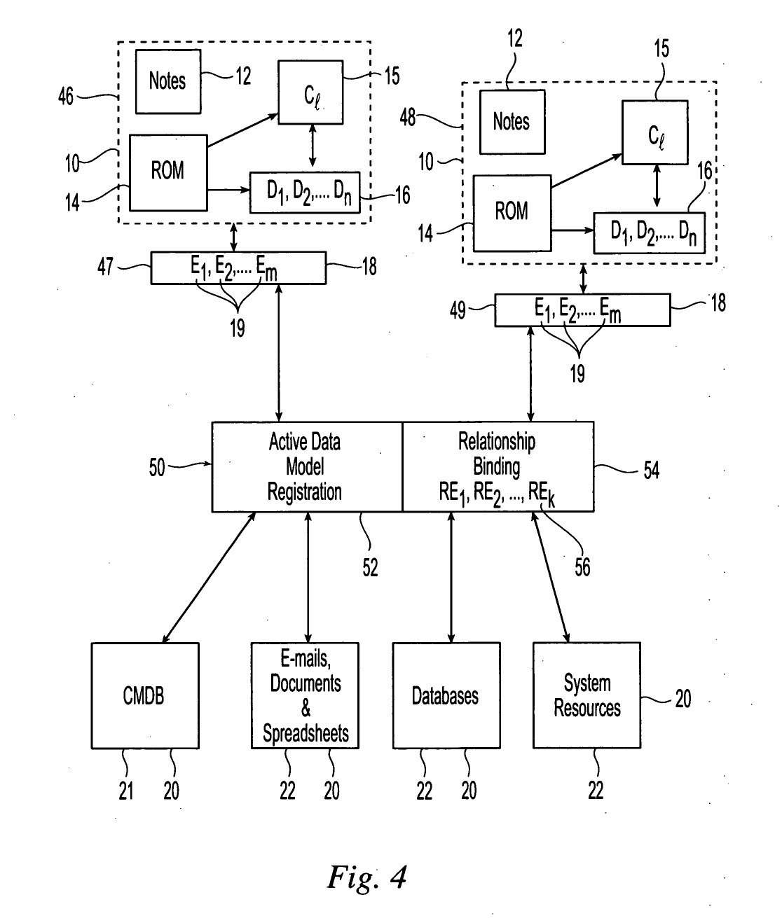

Referring to FIG. 4, in one embodiment, a coordination adapter 50 is provided to interface with the elements 19 of two or more active data models 18 that are associated with two or more structured documents 10. The coordination adapter provides routing, and in particular relational routing, from the various elements 19 within the active data models to the appropriate sources of data 20 in such a way as to enhance system performance and the utilization of system resources. As illustrated, the coordination adapter is providing relational routing for two structured documents, a first structured document 46 and a second structured document 48. The first structured document is associated with a first active data model 47, and the second structured document is associated with a second active data model 49. Although illustrated with two structured documents and two active data models, the coordination adapter can handle any number of a plurality of structured documents and associated active data models.

The coordination adapter 50 includes an active data model registration section 52 for registering elements from the active data models. The coordination adapter also includes a relationship binding section 54 that binds relationships, i.e. routing relationships, between the registered elements and a source of data for each element. In particular, relationship binding involves finding a trusted source for the appropriate data. Suitable sources include centralized sources including manage data sources such as the CMDB and alternative sources such as other elements within one of the active data models or a data point from one of the structured documents. By associating an element from an active data model with a source other than a centralized source, the need for all of the active data elements to contact a single centralized source is reduced, saving time and system resources.

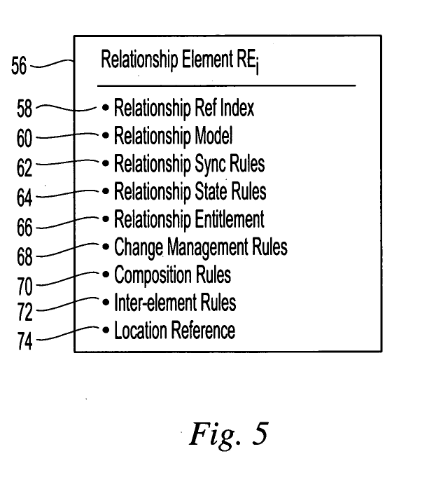

The result of the relationship binding is a plurality of relationship elements 56. Each relationship element represents the binding of one element from an active data model with a suitable source of data. As shown in FIG. 5, a given relationship element 56 includes a relationship reference index 58, which provides referential information for the association between the coordinated model elements much like the location reference does for a model element, a relationship model 60, which provides interconnection information regarding the models used in the coordination, that is, which models can be coordinated and the roles of these models in the coordination, relationship synchronization rules 62, which define the order and manner in which model elements are to be synchronized, relationships state rules 64, which define the lifecycle state for a composition element, relationship entitlement 66, which defines the authorization and authentication policies for a coordination, change management rules 68, which define the rules under which relationships can change, composition rules 70, which define the policies under which models in the relationship model can be composed, inter-element rules 72, which provide the specification of additional rules used in a composition, location reference 74 and combinations thereof.

The location reference component provides details on the location of the data source, for example the trusted or structured data source such as the CMDB or another data element, from which the appropriate and trusted information can be obtained. In addition to address or routing information, these details include other information such as access details. The relationship synchronization rule component provides the synchronization semantics for this relationship element. Examples of the synchronization semantics include, but are not limited to, whether the synchronization is uni-directional or bidirectional, whether the synchronization will occur while the system is online or offline, the synchronization schedule, whether updates are allowed, whether there are other models or model elements that need to be synchronized and combinations thereof. The relationship state rules component provides lifecycle state information for the active data model element. The relationship entitlement rules component provides access, authentication, and entitlement information for the active data model element. The change management rules component provides details of the change management requirement for this active data model element. For example, this component provides details about whether or not the data element is under change control. Alternatively, this component provides pointers to a source of this information. The composition rules component provides composition capabilities if the active data model element is derived from other active data model elements. For example, the composition rules component provides the necessary location references to one or more underlying elements from which this data element is derived. In addition, information about any operations among the underlying elements is also provided. The inter-element rules component provides details on how this data element interacts with other active data model elements.

In general, the coordination adapter 50 manages the modification of an active data model's interconnection behavior based on the registration of a given active data model or given user to the coordination adaptor. As is shown in FIG. 4, the coordination adapter or coordination broker interfaces with multiple externalized active data models, providing a facility to manage and alter the behavior of the active data models and their data elements with regard to obtaining relevant system information for the structured documents. These behaviors are managed through prescribed relationships and the associated sub-objects as described earlier. The various “behaviors” of these models can vary. One illustrative behavior would be that a configuration data value stored in a non-authoritative E-mail note be coordinated with and receive its update values from the active data model for a particular build sheet. Both the active data model for the non-authoritative E-mail note and the build sheet would be registered with the coordination adaptor, and the behavior association would be made. Those skilled in the art could compose very complex and “stitched” behaviors that could facilitate enterprise wide business processes in which a coordination involves multiple active data models with complex relationships between them. Conversely, relationships could be as simplistic as data element mappings between external models propagating data in linear fashion as illustrated by the E-mail note scenario earlier.

The coordination adaptor brokers relationships between multiple active data models and provides a generic mechanism for accessing data value information between active data models in a systematic fashion. In addition, the coordination adapter has the potential to modify the realization of the data access behavior. Characteristics of the coordination adapter include, but are not limited to, a representation of specific relationships between externalized active data models so that reference to a particular data value in an active data model can be traced through references to other active data models. The characteristics also include a mechanism that maintains relationships and enforces rules and references within the boundaries of these relationships to enable the notion of data shortcuts that emulate data sources between externalized active data models.

In one example, portions of a spreadsheet model's data elements are the source of data for a word processor based model. The spreadsheet model manages data associated with a given business process. The word processor based model manages a separate business process that utilizes a portion of the data associated with the spreadsheet model. The coordination adaptor registers the spreadsheet active data model and binds a relationship between the elements of the spreadsheet active data model and the configuration management database (CMDB). Therefore, the spreadsheet active data model will access this centralized, managed data source directly to obtain the desired data. The coordination adapter also registers the word processor based active data model; however the relationship binding of the word processor based model is linked to the spreadsheet model. Therefore, the word processor based model will not access centralized database but instead will access the spreadsheet model to obtain the desired data. With the relationship elements in place, data can be manipulated in the spreadsheet active data model. As information is needed from the word processor based active data model, the coordination adapter manages the appropriate relationship elements and the associated location references to source these data from the spreadsheet model.

Use of the coordination adapter assures an administrator that the data obtained, even if from an alternate source represents managed and trusted data. Time and resource consuming access to a centralized managed source, e.g. the CMDB, is not necessary, as data value integrity is being maintained. Although the described example represents a rather simple and limited number of active data models, systems and methods in accordance with the present invention can be used to coordinate data sourcing for larger and more complex arrangements of structured documents and active data models including, for example a meshed relationship of active data models bound by rules and implemented by references to alter the behavior of several inter-related models.

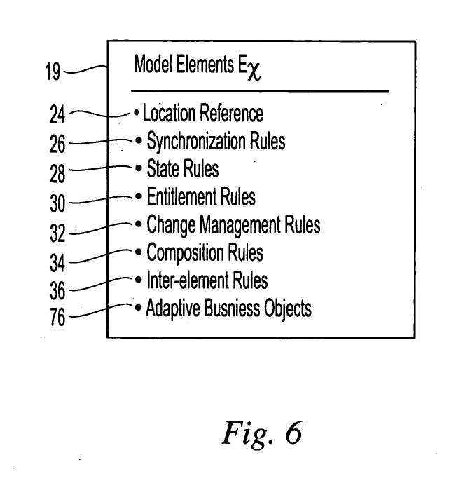

In one embodiment, adaptive business objects (ABO) are utilized in the management of the systems. An ABO is an abstraction of a business entity with explicitly managed state. As used herein, an ABO represents a decomposition of data in a system into a business object that has a set of states. The business object transitions through these states, and the available data at any given time is a reflection of the current state of the business object. In particular, the active data models are decomposed into non-overlapping adaptive business objects in accordance with analysis of lifecycle states and data attributes. Illustratively, a build sheet may be comprised of a selection of data some of which is used to represent a server configuration, some of which is used to represent a network configuration. The build sheet may then be decomposed into a set of separable non-overlapping business objects, e.g. server and network, each of which is represented as a subset of the active data model, and these are associated with abstract business objects. As shown in FIG. 6, this decomposition results in each model element 19 containing an adaptive business object reference 76. Although a build sheet is a useful and practical document for the service delivery management (SMD) environment, the build sheet fails to provide a clean separation from a business artifact viewpoint. That is, separations are adequate in the management environment, but not in the business artifact environment and various business objects can be represented in the elements of a single build sheet. For example, the build sheet may include elements of a server change request ABO and a network change ABO among others. Exemplary embodiments in accordance with the present invention provide a methodology by which a scattered data object can be expressed as a number of composite ABO's and shows, as part of the Active Data Model, how these are related back to the ABO's so that the data integrity and mapping is maintained. The ABO Refs component 76 is responsible for providing the relationships mapping between a model element of a model and any related ABOs. This component will interact with the state rules and location rules to map this element to one or more ABOs.

Exemplary methods in accordance with the present invention include methods for managing computing systems such as information technology systems by utilizing active data models, coordination adaptors and adaptive business objects. Structured documents, for example build sheets or spreadsheets are used by an administrator to manage or to control the organization and operation of a given information technology system. In one embodiment, each structured document is created for a particular system, for example by the system administrator. The structured documents contain data elements that contain the parameters used to manage the information technology system. The representations of these data elements contained within the structured document are synchronized with representations of these data elements contained in one or more data sources. These data sources include managed data sources, trusted data sources, scattered data sources and combinations thereof. Synchronization of the data elements representations includes wherein the step of synchronizing further comprises obtaining updated representations of the data elements from the data sources and replacing existing representations of the data elements in the structured document with the updated representations of the data elements. Similarly, representations of the data elements in the structured document are used to replace the representations of the data elements in the data source. Preferably, synchronization involves establishing a two-way exchange of the representations of the data elements between the structured document and the data sources.

Synchronization of the data elements is facilitated by using an active data model that is in communication with both the structured document and the data sources. The active data model includes one or more, and preferably a plurality of model elements. Each model element is associated with one of the data elements contained within the structured document. Therefore, the model element is an active representation of the data element that is arranged to facilitate locating, reading and updating the data element. This functionality is enabled by including in each model element information sufficient to facilitate communication of data element representations between the structured document and the data sources. The information sufficient to facilitate communication contained in each model element includes, but is not limited to, a location reference, synchronization rules, state rules, entitlement rules, change management rules, composition rules, inter-element rules and combinations thereof.

Having created the structured document containing a plurality of elements, one or more of the data elements in the structured document are identified for synchronization. Not all of the data elements within a structured document are necessarily identified for synchronization. Certain data elements may be ready only or may be calculated from other data elements within the structured document. Alternatively certain data elements may not be selected because it is neither desired nor required that these data elements be synchronized with an external data source. In one embodiment, the active data model is created to include a model element for each one of the identified data elements. The total number of model elements can be varied based upon the administrative demands of the system up to a number of model elements equal to the number of representations of data elements within the structured document that are subject to synchronizing. In one embodiment, the structure of the active data model and the model elements contained within the active data model are constructed specifically for a given information technology system and structured document. Alternatively, the active data model is created from a generic or sample active data model. For example, the generic active data model is modified in accordance with the data elements and data sources associated with management of a given information technology system.

In one embodiment, management of the information technology system includes creating a composite active data model to be used in managing the information technology system. A composite active data model is formed from existing active data models having model elements that relate to data elements that are also contained in the structured document for which the composite active data model is being created. In one embodiment, two or more existing active data models are identified. Each existing active data model includes at least one model element associated with a data element contained in a structured document. Model elements from the identified existing active data models are used to create the composite active data model. As with other active data models, the composite active data model is used to obtain updates from one or more data sources for the data elements contained in the structured document. Therefore, the composite active data model is used to synchronize representations of data elements contained in the structured document with representations of the data elements contained in data sources for the data elements using the composite active data model. The composite active data element contains one or more composite elements, i.e. elements obtained from the existing active data models, and one or more connection elements. The connection elements contain information regarding relationships between the various existing model elements in the composite model elements. Although the composite active data model utilizes existing active data models as a source for model elements, not all of the models elements have to come from existing active data models. In one embodiment, creation of the composite active data model also includes creating one or more new model elements in accordance with the requirements of the information technology system for which the structured document is arranged to manage.

In one embodiment, management of the information technology system involves creating a coordination adaptor to coordinate routing of the synchronization enacted by the active data model from the data elements in the structured documents to the data elements in the data sources. In particular, the coordination adaptor coordinates routing and sourcing of data elements from sources other than the centralized repositories for these data elements while maintaining the level or trust and integrity associated with the centralized data repositories. Sourcing trust data elements from alternative sources increases the speed of synchronization and the efficiency of system management.

As was stated, updates for data elements are obtained form a variety of data sources from scattered data sources to managed data sources. Centralized and managed data sources are generally associated with a higher level of trust, as the contents of these data sources are managed or controlled. Therefore, in one embodiment, trusted data sources are identified, and the representations of the data elements within the structured document are synchronized with the trusted data sources. In one embodiment, a register, database or list containing each one of the model elements of the active data model or composite active data model is created. For each one of the data elements associated with the registered model elements, a trusted data source is identified, and this trusted data source is associated with each one of the data elements associated with the registered model elements. Association of a trusted data source involves binding routing relationships between the data elements associated with each one of the registered model elements and the associated trusted data source. These binding routing relationships are used to find and access the associated trusted data source for purposes of synchronization or obtaining updates. Suitable associations include, but are not limited to, a centralized data source, a data element from a structured document, a model element from an active data model and combinations thereof. In one embodiment, creation of the binding routing relationships includes defining a plurality of relationship elements, where each relationship element includes an identification of a data element from a structured document, an identification of a trust data source, a relationship reference index and a relationship model.

In one embodiment, adaptive business objects are utilized in the management of the information technology system. In order to utilize adaptive business objects, the active data model is decomposed into a plurality of non-overlapping adaptive business objects. These adaptive business objects are then utilized in the management of the information technology system. Management is further facilitated by modifying each model element to include an adaptive business object reference.

Methods and systems in accordance with exemplary embodiments of the present invention can take the form of an entirely hardware embodiment, an entirely software embodiment or an embodiment containing both hardware and software elements. In a preferred embodiment, the invention is implemented in software, which includes but is not limited to firmware, resident software and microcode. In addition, exemplary methods and systems can take the form of a computer program product accessible from a computer-usable or computer-readable medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which provide temporary storage of at least some program code in order to reduce the number of times code must be retrieved from bulk storage during execution. Input/output or I/O devices, including but not limited to keyboards, displays and pointing devices, can be coupled to the system either directly or through intervening I/O controllers. Exemplary embodiments of the methods and systems in accordance with the present invention also include network adapters coupled to the system to enable the data processing system to become coupled to other data processing systems or remote printers or storage devices through intervening private or public networks. Suitable currently available types of network adapters include, but are not limited to, modems, cable modems, DSL modems, Ethernet cards and combinations thereof.

In one embodiment, the present invention is directed to a machine-readable or computer-readable medium containing a machine-executable or computer-executable code that when read by a machine or computer causes the machine or computer to perform a method for the management of information technology systems in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A method for managing information technology systems, the method comprising:
synchronizing representations of data elements contained in a structured document with representations of the data elements contained in data sources for the data elements by using an active data model in communication with both the structured document and the data sources, the active data model comprising one or more model elements, each model element associated with one of the data elements and comprising information sufficient to facilitate communication of data element representations between the structured document and the data sources, wherein the data elements in the structured document comprise parameters used to manage an information technology system.

2. The method of claim 1, wherein the information sufficient to facilitate communication contained in each model element comprises a location reference, synchronization rules, state rules, entitlement rules, change management rules, composition rules, inter-element rules or combinations thereof.

3. The method of claim 1, further comprising:
creating the structured document containing the data elements;
identifying one or more of the data elements in the structured document for synchronization; and
creating the active data model comprising a model element for each one of the identified data elements.

4. The method of claim 3, wherein the step of creating the active data model comprises modifying a generic active data model in accordance with the data elements and data sources associated with management of the information technology system.

5. The method of claim 1, wherein the active data model comprises a composite active data model and the method further comprises:
identifying two or more existing active data models, each existing active data model comprising at least one model element associated with one of the data elements contained in the structured document; and
creating the composite active data model using model elements from the identified existing active data models.

6. The method of claim 5, wherein the composite active data model comprises one or more composite elements and one or more connection elements, each connection element comprising information regarding relationships between the various existing model elements in the composite model elements.

7. The method of claim 5, wherein the step of creating the composite active data model further comprises creating new model elements in accordance with the requirements of the information technology system for which the structured document is arranged to manage.

8. The method of claim 1, wherein the step of synchronizing further comprises obtaining updated representations of the data elements from the data sources and replacing existing representations of the data elements in the structured document with the updated representations of the data elements.

9. The method of claim 1, wherein the structured document comprises a spreadsheet.

10. The method of claim 1, wherein the step of synchronizing comprises establishing a two-way exchange of the representations of the data elements between the structured document and the data sources.

11. The method of claim 1, wherein the data sources comprise managed data sources, scattered data sources or combinations thereof.

12. The method of claim 1, wherein the active data model comprises a number of model elements equal to the number of representations of data elements within the structured document that are subject to synchronizing.

13. The method of claim 1, wherein the step of synchronizing further comprises:
creating a register containing each one of the model elements of the active data model;
identifying a trusted data source for each one of the data elements associated with the registered model elements; and
associating a trusted data source with each one of the data elements associated with the registered model elements.

14. The method of claim 13, wherein the step of associating a trusted data source further comprises binding routing relationships between the data elements associated with each one of the registered model elements and the associated trusted data source.

15. The method of claim 13, wherein the step of associating a trusted data source comprises associating a centralized data source, a data element from a structured document, a model element from an active data model or combinations thereof.

16. The method of claim 14, wherein the step of binding routing relationships further comprises defining a plurality of relationship elements, each relationship element comprising an identification of a data element from a structured document, an identification of a trust data source, a relationship reference index and a relationship model.

17. The method of claim 1, further comprising decomposing the active data model into a plurality of non-overlapping adaptive business objects; and
utilizing the adaptive business objects in the management of the information technology system.

18. The method of claim 17, further comprising modifying each model element to include an adaptive business object reference.

19. A method for managing information technology systems, the method comprising:
creating a composite active data model by identifying two or more existing active data models, each existing active data model comprising at least one model element associated with a data element contained in a structured document and using model elements from the identified existing active data models to create the composite active data model; and
using the composite active data model to obtain updates from one or more data sources for the data elements contained in the structured document;
wherein each model element comprises information sufficient to facilitate communication of data element updates from the data sources to the structured document.

20. The method of claim 19, wherein the step of using the composite active data model to obtain updates further comprises synchronizing representations of data elements contained in the structured document with representations of the data elements contained in data sources for the data elements using the composite active data model.

21. The method of claim 19, wherein the composite active data model comprises one or more composite elements and one or more connection elements, each connection element comprising information regarding relationships between the various existing model elements in the composite model elements.

22. The method of claim 19, wherein the step of creating the composite active data model further comprises creating new model elements in accordance with the requirements of the information technology system for which the structured document is arranged to manage.

23. A method for managing information technology systems, the method comprising:
creating a register containing each one of a plurality of model elements contained in an active data model, each model element associated with a data element and comprising information sufficient to facilitate communication of that data element between a structured document and a data source, wherein the data elements in the structured document comprise parameters used to manage an information technology system;
identifying a trusted data source for each one of the data elements associated with the registered model elements; and
associating a trusted data source with each one of the data elements associated with the registered model elements.

24. The method of claim 23, wherein the step of associating a trusted data source further comprises binding routing relationships between the data elements associated with each one of the registered model elements and the associated trusted data source.

25. The method of claim 23, wherein the step of associating a trusted data source comprises associating a centralized data source, a data element from a structured document, a model element from an active data model or combinations thereof.

26. The method of claim 24, wherein the step of binding routing relationships further comprises defining a plurality of relationship element, each relationship element comprising an identification of a data element from a structured document, an identification of a trust data source, a relationship reference index and a relationship model.

27. A method for managing information technology systems, the method comprising:
decomposing an active data model into a plurality of non-overlapping adaptive business objects, the active data model comprising one or more model elements, each model element associated with a data element and comprising information sufficient to facilitate communication of data element representations between a structured document and a data source, wherein the data elements are contained in a structured document and comprise parameters used to manage an information technology system; and
utilizing the adaptive business objects in the management of the information technology system

28. The method of claim 27, further comprising modifying each model element to include an adaptive business object reference.

29. A computer-readable medium containing a computer-readable code that when read by a computer causes the computer to perform a method for managing information technology systems, the method comprising:
synchronizing representations of data elements contained in a structured document with representations of the data elements contained in data sources for the data elements by using an active data model in communication with both the structured document and the data sources, the active data model comprising one or more model elements, each model element associated with one of the data elements and comprising information sufficient to facilitate communication of data element representations between the structured document and the data sources, wherein the data elements in the structured document comprise parameters used to manage an information technology system.

30. The computer readable medium of claim 29, wherein the method further comprises:
creating the structured document containing the data elements;
identifying one or more of the data elements in the structured document for synchronization; and
creating the active data model comprising a model element for each one of the identified data elements.

31. The computer readable medium of claim 30, wherein the step of creating the active data model comprises modifying a generic active data model in accordance with the data elements and data sources associated with management of the information technology system.

32. The computer readable medium of claim 29, wherein the active data model comprises a composite active data model and the method further comprises:
identifying two or more existing active data models, each existing active data model comprising at least one model element associated with one of the data elements contained in the structured document; and
creating the composite active data model using model elements from the identified existing active data models.

33. The computer readable medium of claim 32, wherein the composite active data model comprises one or more composite elements and one or more connection elements, each connection element comprising information regarding relationships between the various existing model elements in the composite model elements.

34. The computer readable medium of claim 29, wherein the step of synchronizing further comprises:
creating a register containing each one of the model elements of the active data model;
identifying a trusted data source for each one of the data elements associated with the registered model elements; and
associating a trusted data source with each one of the data elements associated with the registered model elements by binding routing relationships between the data elements associated with each one of the registered model elements and the associated trusted data source.

35. The computer readable medium of claim 29, wherein the method further comprises decomposing the active data model into a plurality of non-overlapping adaptive business objects; and
utilizing the adaptive business objects in the management of the information technology system.
